(19) United States
(12) Patent Application Publication
(10) Pub. No.: US 2016/0157133 A1
(43) Pub. Date: Jun. 2, 2016

(54) THROTTLING MECHANISM FOR DOWNLINK TRANSMISSION CONTROL

(71) Applicant: QUALCOMM Incorporated, San Diego, CA (US)

(72) Inventors: Navid Ehsan, San Diego, CA (US); Parthasarathy Krishnamoorthy, San Diego, CA (US); Brian Clarke Banister, San Diego, CA (US); Jon James Anderson, Boulder, CO (US); Anand Rajurkar, Hyderabad (IN); Janga Reddy Alimineti, Hyderabad (IN); Raghavendra Shyam Anand, Hyderabad (IN); Krishna Kumar Vasanthasenan, Hyderabad (IN); Prashanth Haridas Mohan, Somerset, NJ (US); Aravinth Rajendran, Hyderabad (IN)

(21) Appl. No.: 14/557,975

(22) Filed: Dec. 2, 2014

(51) Int. Cl. H04W 28/22; H04W 72/08; H04W 24/08

(52) U.S. Cl. CPC H04W 28/22; H04W 24/08; H04W 72/085

(57) ABSTRACT

A throttling mechanism for downlink transmission control is disclosed, in which, in one aspect, a downlink low data-rate transmission may be received at a user equipment (UE). The UE may then measure a performance metric indicating performance of the downlink low data-rate transmission. The UE controls the downlink low data-rate transmission by dynamically adjusting the number of receiving antennas in use in response to comparison results of the performance metric and a threshold value.

### BACKGROUND

1. Field

Aspects of the present disclosure relate generally to wireless communication systems, and more particularly, to a throttling mechanism for downlink transmission control.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or eNnode-Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance communication technologies not only to meet the growing demand for mobile broadband access, but to advance and enhance the user experience with mobile communications.

Generally, UEs are more limited in the ability to process data transmission than base stations due to their hardware limitations. As such, the processing and power limitations of UEs may be more easily reached resulting in degradation of mobile communication quality. Accordingly, research and development continues to advance and enhance the user experience with mobile communications by improving UEs' methods and systems to process data and manage power consumption.

### SUMMARY

In one aspect of the disclosure, a method for wireless communication is disclosed. The method includes determining, by a user equipment (UE), a downlink low data-rate transmission received at the UE, measuring, by the UE, a performance metric indicating performance of the downlink low data-rate transmission, and controlling, by the UE, the downlink low data-rate transmission. The controlling includes dynamically adjusting the number of receiving antennas in use by the UE in response to comparison results of the performance metric and a threshold value.

In an additional aspect of the disclosure, an apparatus for wireless communication is disclosed. The apparatus includes means for determining a downlink low data-rate transmission received at a user equipment (UE), means for measuring a performance metric indicating performance of the downlink low data-rate transmission, and means for controlling the downlink low data-rate transmission. The means for controlling includes means for dynamically adjusting the number of receiving antennas in use by the UE in response to comparison results of the performance metric and a threshold value.

In an additional aspect of the disclosure, a non-transitory computer-readable medium for wireless communications is disclosed. The non-transitory computer-readable medium includes program code recorded thereon. The non-transitory computer-readable medium includes program code for causing a computer to determine a downlink low data-rate transmission received at a user equipment (UE), program code for causing the computer to measure a performance metric indicating performance of the downlink low data-rate transmission, and program code for causing the computer to control the downlink low data-rate transmission. The program code to control includes program code to dynamically adjust the number of receiving antennas in use by the UE in response to comparison results of the performance metric and a threshold value.

In an additional aspect of the disclosure, a wireless communication apparatus is disclosed. The wireless communication apparatus includes at least one processor and a memory coupled to the at least one processor. The at least one processor is configured to determine a downlink low data-rate transmission received at a user equipment (UE), to measure a performance metric indicating performance of the downlink low data-rate transmission, and to control the downlink low data-rate transmission. The configuration of the at least one processor to control includes configuration to dynamically adjust the number of receiving antennas in use by the UE in response to comparison results of the performance metric and a threshold value.

The foregoing has outlined rather broadly the features and technical advantages of the present application in order that the detailed description that follows may be better understood. Additional features and advantages will be described hereinafter which form the subject of the claims. It should be appreciated by those skilled in the art that the conception and specific aspect disclosed may be readily utilized as a basis for modifying or designing other structures for carrying out the same purposes of the present application. It should also be realized by those skilled in the art that such equivalent constructions do not depart from the spirit and scope of the present application and the appended claims. The novel features which are believed to be characteristic of aspects, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present claims.

### BRIEF DESCRIPTION OF THE DRAWINGS

FIG. 1 is a diagram illustrating an example of a telecommunications system.

FIG. 2 is a block diagram illustrating an example of a down link frame structure in a telecommunications system.

FIG. 3 is a block diagram illustrating a design of a base station and a UE configured according to one aspect of the present disclosure.

FIG. 4 is a functional block diagram illustrating exemplary blocks executed to implement one aspect of the present disclosure.

FIG. 5 is a functional block diagram illustrating exemplary blocks executed to implement one aspect of the present disclosure.

FIG. 6 is a block diagram of a UE in a communication network according to one aspect of the present disclosure.

FIG. 7 is a functional block diagram illustrating exemplary blocks executed to implement one aspect of the present disclosure.

FIG. 8 is a block diagram of a UE in a communication network according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

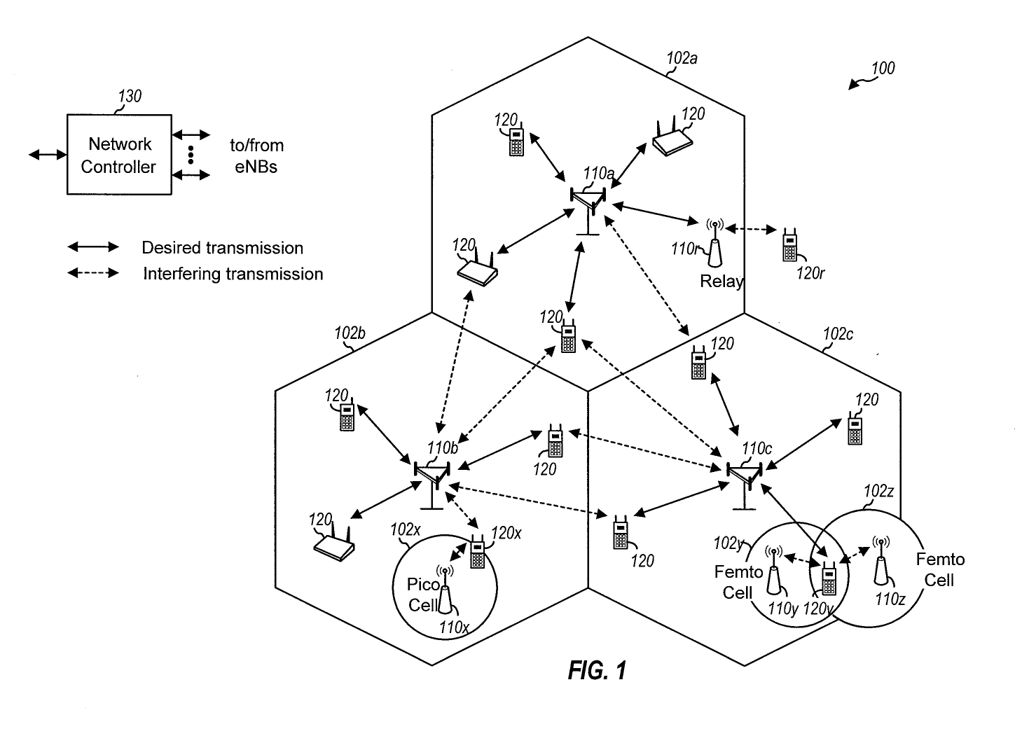

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB (HeNB). In the example shown in FIG. 1, the eNBs 110a, 110b and 110c may be macro eNBs for the macro cells 102a, 102b and 102c, respectively. The eNB 110x may be a pico eNB for a pico cell 102x, serving a UE 120x. The eNBs 110y and 110z may be femto eNBs for the femto cells 102y and 102z, respectively. An eNB may support one or multiple (e.g., three) cells.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a smart phone, a tablet, a wireless local loop (WLL) station, or other mobile entities. A UE may be able to communicate with macro eNBs, pico eNBs, femto eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

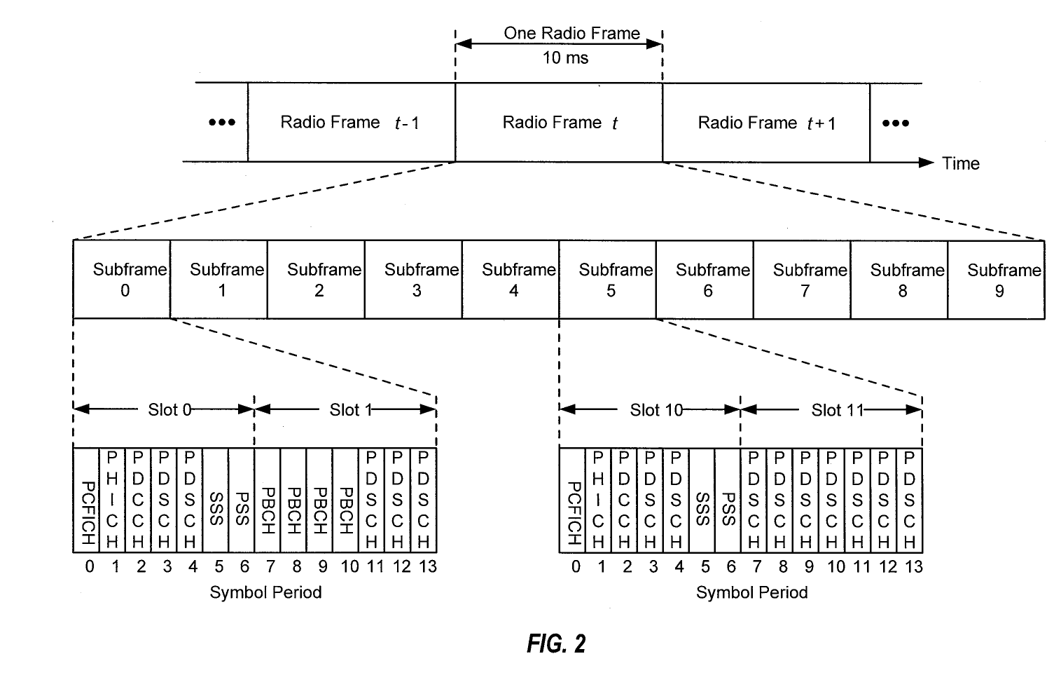

FIG. 2 shows a down link frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

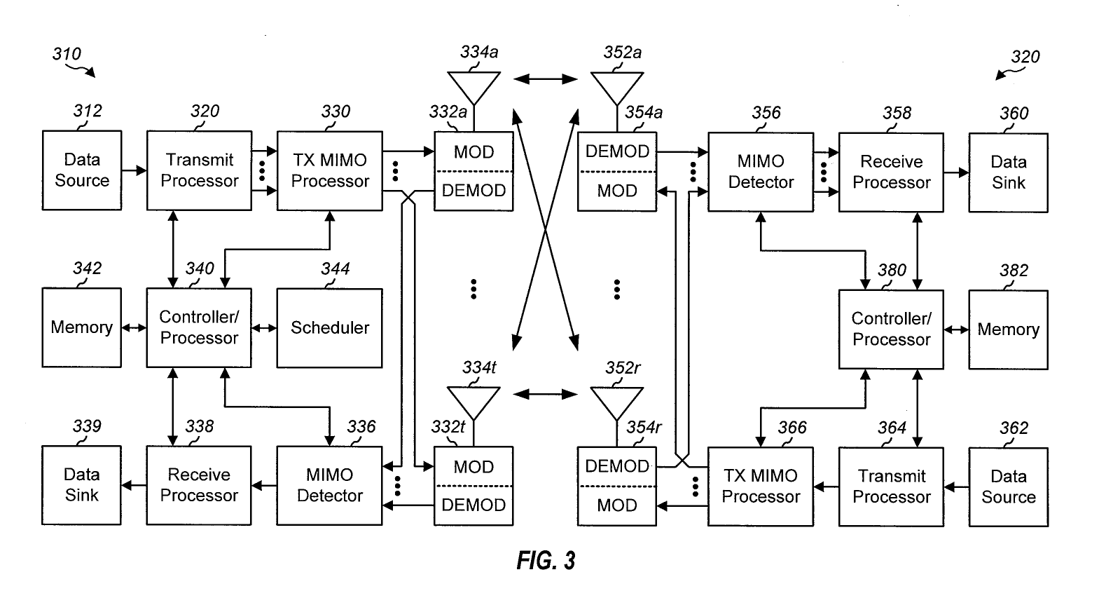

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

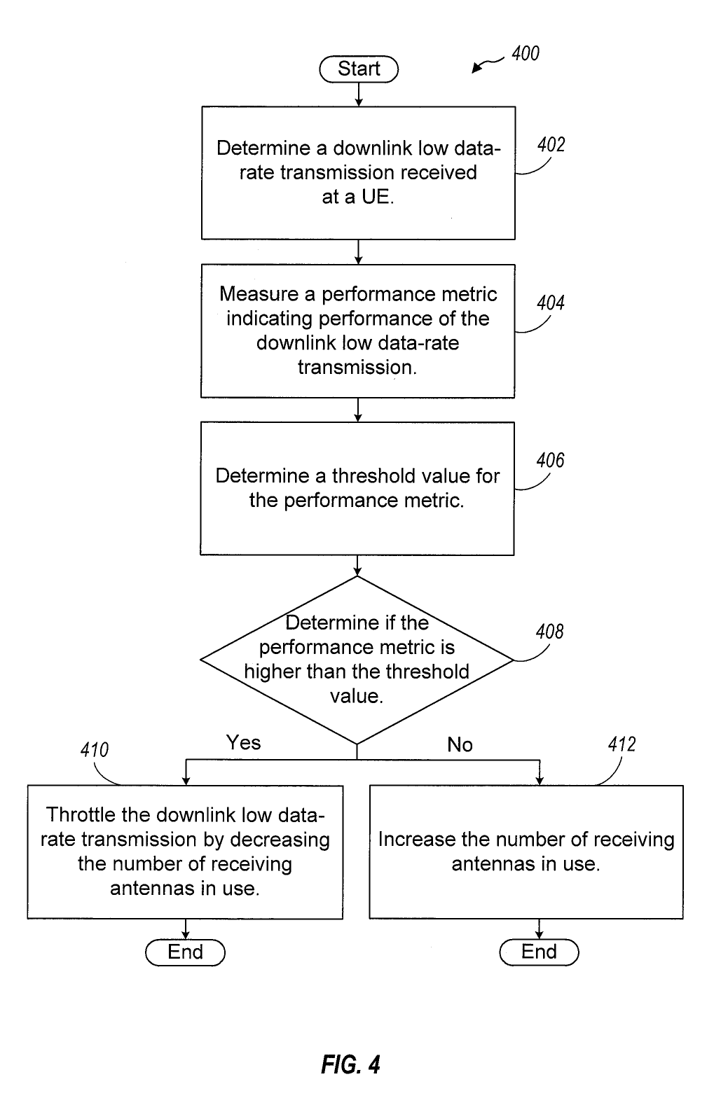

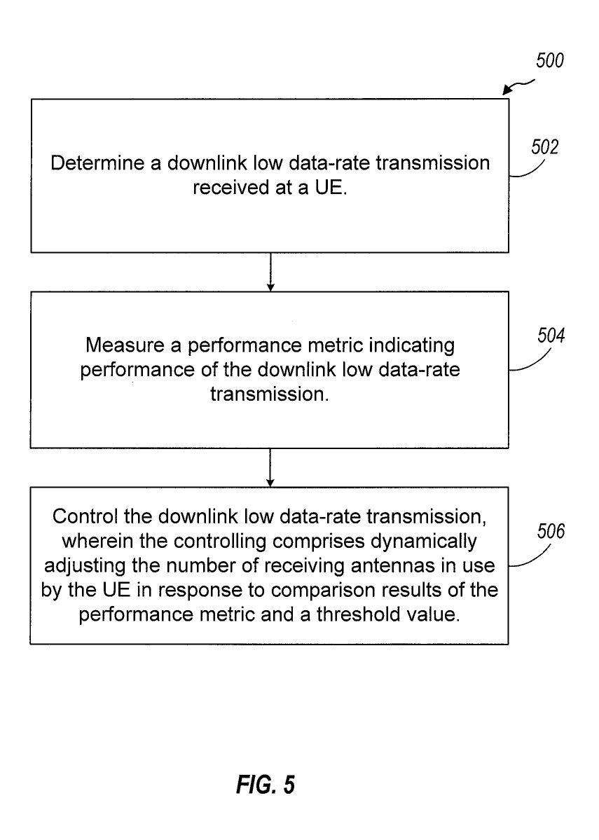

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

Communication devices, such as UEs, may be configured to operate on different types of communication networks that use different Radio Access Technologies (RATs) and Radio Access Networks (RANs) for different types of data transmission. Accordingly, UEs may be switched between a first RAN supporting a first RAT and a second RAN supporting a second RAT. For example, in order to make or receive a voice call, a UE in a packet-switched (PS) network, such as a data-centric LTE network that only provides data services, may switch to a circuit-switched (CS) network that provides voice services through a 1x circuit-switched fallback (CSFB) or an enhanced 1x circuit-switched fallback (e1xCSFB). After the voice call completes, the UE may return to the data-centric LTE network, if available. The CS network may also be referred as a 1x network, a 1x CS network, a 1x voice network, a voice-capable network, or the like. Generally, data services may use a higher data transmission rate to maintain the quality of data transmission, whereas voice services may use a relatively lower data transmission rate than the data transmission rate for data services. UEs that are capable of supporting different RATs for different services may be simultaneous voice and LTE (SVLTE) UEs or Multi-SIM UEs.

For clarity, the LTE network referred to above may be a traditional LTE network that is a data-only LTE network restricted to data-centric PS communications and does not provide voice services. However, advancing LTE technologies have provided new systems that include delivery of voices services over the LTE network. Such systems are referred to as voice over LTE (VoLTE) networks. VoLTE networks may provide PS-based voice services in addition to data services. UEs capable of utilizing the VoLTE network may be referred to as VoLTE UEs. VoLTE UEs may support both low and high data-rate applications for voice and data services respectively. VoLTE may be one of the low data-rate applications which require relatively low data transmission rates. In other words, VoLTE is one non-limiting example involving a low data-rate transmission, and the present disclosure is applicable to other low-data rate transmission applications. The high data-rate applications may be used to process data services and other uplink and downlink transmissions that use relatively high data transmission rates.

A UE may have inherent hardware constraints and power consumption issues, and such constraints and issues may affect the UE's capability to support more advanced operational modes, such as Multiple Input Multiple Output (MIMO) mode, carrier aggregation mode, or the like. A UE's hardware limitations may include Bus contention and/or CPU limitations. However, not all data transmission requires advanced operational modes. Data transmission may include data services (e.g., packet transmission, video transmission, and transmission using a relatively high data transmission rate) and voice services (e.g., voice call using a relatively low data transmission rate). Aspects of the present disclosure include UEs with the flexibility to switch operational modes based on the types of data transmission the UE may be handling and performance of the data transmission to avoid reaching hardware limitations and/or to save power.

Various aspects of the present disclosure provide that different types of UEs may have different ways to adjust operational modes to avoid reaching hardware limitations and/or to save power. In some aspects of the present disclosure, a SVLTE UE or Multi-SIM UE may switch from a carrier aggregation mode to a non-carrier aggregation mode to throttle back downlink data transmissions when the UE's hardware limitations limit or about to limit its capability to support voice services and data services simultaneously in a carrier aggregation mode or when the SVLTE UE or Multi-SIM UE is approaching its hardware throughput limitations. Accordingly, the SVLTE UE or Multi-SIM UE may avoid exceeding its hardware limitations. Exceeding the hardware limitations may result in degraded performance of data transmission or system failure.

Such operational mode switches may be achieved by a SVLTE UE or Multi-SIM UE signaling one or more base stations to drop at least one carrier of the carriers that are configured for the UE (e.g., a LTE-secondary carrier). For example, a SVLTE UE or Multi-SIM UE may signal one or more base stations to drop a LTE-secondary carrier for data services when receiving a voice call. As a further example, a SVLTE UE or Multi-SIM UE may signal one or more base stations to drop a LTE-secondary carrier to cap the Bus and/or CPU peak throughput when it approaches its hardware throughput limitations. In order to request a base station to drop at least one carrier, a SVLTE UE or Multi-SIM UE may signal the base station a false indicator value. The false indicator value indicates false channel state information of the carrier to be dropped. The false channel state information of the carrier is worse than actual channel state information of the carrier to be dropped. The false indicator value may be a false channel quality indicator (CQI) value. The false indicator value may be pre-determined to be used to cause the one or more base stations to drop the at least one carrier.

In addition, a SVLTE UE or Multi-SIM UE may increase the frequency or amount of transmission of negative acknowledgements (NACKs) for the data transmission that exceeds the frequency or amount of transmission of NACKs needed to report errors in the data transmission. The frequency or amount of transmission of NACKs is false. The false frequency or amount of transmission of NACKs may be pre-determined to be used to cause one or more base stations to drop at least one carrier. Correspondingly, the base station that receives the false indicator value indicating degraded channel state information of the carrier and/or the false amount of NACKs from the SVLTE UE or Multi-SIM UE may stop data transmission on the carrier that the SVLTE UE or the Multi-SIM UE intends to drop.

In some aspects of the present disclosure, a VoLTE UE or UE capable of supporting both low and high data-rate applications, such as a UE utilizing WCDMA, may switch from a MIMO mode to a non-MIMO mode (e.g., a Single-Input-Single-Output (SISO) mode) to save power when it receives or is about to receive services that require a relatively low data transmission rate (hereinafter referred to as “low data-rate transmission”). The low data-rate transmission may include voice services or services requiring a relatively low data transmission rate. In some embodiments, a VoLTE UE or UE capable of supporting both low and high data-rate applications may dynamically adjust the number of receiving antennas in use according to performance of low data-rate transmission. For example, the quality performance of voice transmission and an associated performance metric of the voice transmission may be determined based on initiation time of the voice transmission, a drop rate of voice transmission, a mean opinion score, or a combination thereof.

FIG. 4 is a functional block diagram 400 illustrating exemplary blocks executed by a UE to implement one aspect of the present disclosure. At block 402, the UE may determine downlink low data-rate transmission at the UE. The low data-rate transmission received from one or more base stations may include voice services or services requiring a relatively low data-rate transmission. The UE may include a low data-rate application to process the low data-rate transmission and a high data-rate application to process high data-rate transmission. At block 404, the UE may measure a performance metric that indicates performance of the downlink low data-rate transmission received from one or more base stations. The performance metric of the downlink low data-rate transmission may be associated with operational modes of the UE and/or the number of receiving antennas that the UE may utilize. At block 406, the UE may determine a threshold value for being compared with the measured performance metric. Alternatively, the threshold value may be determined before measuring a performance metric, as indicated at block 404. The threshold value may serve as a threshold to trigger downlink transmission control by the UE and/or operational mode switch. The threshold value may be implementation specific. Alternatively, the threshold value may be either statically or dynamically configurable during run-time of the UE. The UE may include a software module to be used to determine one or more threshold values and maintain the one or more threshold values during operation.

It is noted that if, however, the UE determines that the downlink transmission received from one or more base stations is a high data-rate transmission (e.g., LTE data services), then, instead of voice services or services using a relatively low data-rate transmission, the UE may remain in operational modes that are able to adequately support the high data-rate transmission. Accordingly, the procedure illustrated in functional block diagram 400 may not be triggered.

At block 408, the UE may determine if the performance metric is higher than the threshold value. If yes, proceed to block 410. At block 410, the UE may throttle the downlink low data-rate transmission. For example, the UE may throttle the downlink low data-rate transmission by decreasing the number of receiving antennas in use. Thus, the operational mode of the UE may be switched from a MIMO mode to a non-MIMO mode. As a result, the UE may save operational power because less receiving antennas are in use. The UE decreasing the number of receiving antennas may show that the performance of downlink low data-rate transmission is good enough for the UE to use less receiving antennas to receive such downlink low data-rate transmission.

Such operational mode switches may be achieved by a SVLTE UE or Multi-SIM UE signaling one or more base stations to drop at least one carrier of the carriers that are configured for the UE (e.g., a LTE-secondary carrier). For example, a SVLTE UE or Multi-SIM UE may signal one or more base stations to drop a LTE-secondary carrier for data services when receiving a voice call. As a further example, a SVLTE UE or Multi-SIM UE may signal one or more base stations to drop a LTE-secondary carrier to cap the Bus and/or CPU peak throughput when it approaches its hardware throughput limitations.

Alternatively, if the UE determines the performance metric is lower than the threshold value at block 408, the process may proceed to block 412. At block 412, the UE may increase the number of receiving antennas in use. Thus, the operational mode of the UE may be switched back to a MIMO mode. The UE increasing the number of receiving antennas in use may show that the performance of downlink low data-rate transmission is not good enough for the UE to use less receiving antennas to receive such downlink low data-rate transmission. The UE may keep monitoring performance of downlink low data-rate transmission in order to dynamically adjust the number of its receiving antennas to control downlink low data-rate transmission accordingly. As such, power consumption of the UE may be improved.

FIG. 5 is a functional block diagram 500 illustrating exemplary blocks executed by a UE to implement one aspect of the present disclosure. At block 502, the UE may determine a downlink low data-rate transmission received at the UE. At block 504, the UE may measure a performance metric indicating performance of the downlink low data-rate transmission. At block 506, the UE may control the downlink low data-rate transmission. For example, the UE may control the downlink low data-rate transmission by dynamically adjusting the number of receiving antennas in use by the UE in response to comparison results of the performance metric and a threshold value. If the performance of the downlink low data-rate transmission changes, the operational modes and/or the number of receiving antennas in use by the UE may be changed. The UE may increase or decrease the number of receiving antennas in use by adjusting a rank indicator. For example, when the rank indicator is forced to 1, the number of receiving antennas in use may decrease from 2 (2 Rx) to 1 (1 Rx) and the second antenna is shut down. As a further example, when the rank indicator increases to 2, the number of receiving antennas in use may increase from 1 (1 Rx) to 2 (Rx) and the second antenna is turned on.

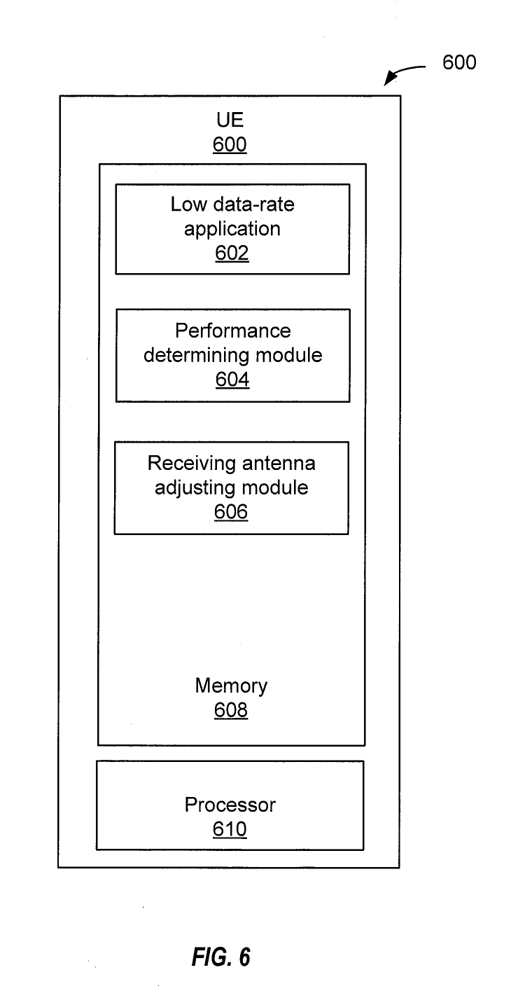

FIG. 6 is a block diagram of a UE 600 in a communication network according to one aspect of the present disclosure. UE 600 may include a memory 608 that may store data and program codes for execution of a low data-rate application 602, a performance determining module 604, and a receiving antenna adjusting module 606. Low data-rate application 602 may be used to process voice services or services requiring a relatively low transmission data rate. UE 600 may further include a high data-rate application that may be used to process data services, such as LTE data services, which is not shown in block diagram of UE 600. UE 600 that includes both low and high data-rate applications may be a VoLTE UE, a WCDMA UE, or a UE supporting both low and high data-rate transmission. Performance determining module 604 may be used to determine a performance metric indicating the performance of downlink low data-rate transmission received from one or more base stations. Performance determining module 604 may further be used to determine a threshold value to be compared with the performance metric. Receiving antenna adjusting module 606 may be used to adjust the number of receiving antennas in use for UE 600 to control downlink low data-rate transmission received from one or more base stations. Receiving antenna adjusting module 606 may increase or decrease the number of receiving antennas in use by UE 600 based on comparison results of the performance metric and threshold value determined by performance determining module 604. When the performance metric is higher than the threshold value, receiving antenna adjusting module 606 may decrease the number of receiving antennas in use. When the performance metric is lower than the threshold value, receiving antennas adjusting module 606 may increase the number of receiving antennas in use.

UE 600 may also include a processor 610 to perform or execute program codes that are stored in memory 608 and control the other components of UE 600. Processor 610 and/or other processors at UE 600 may also perform or direct the execution of the functional blocks.

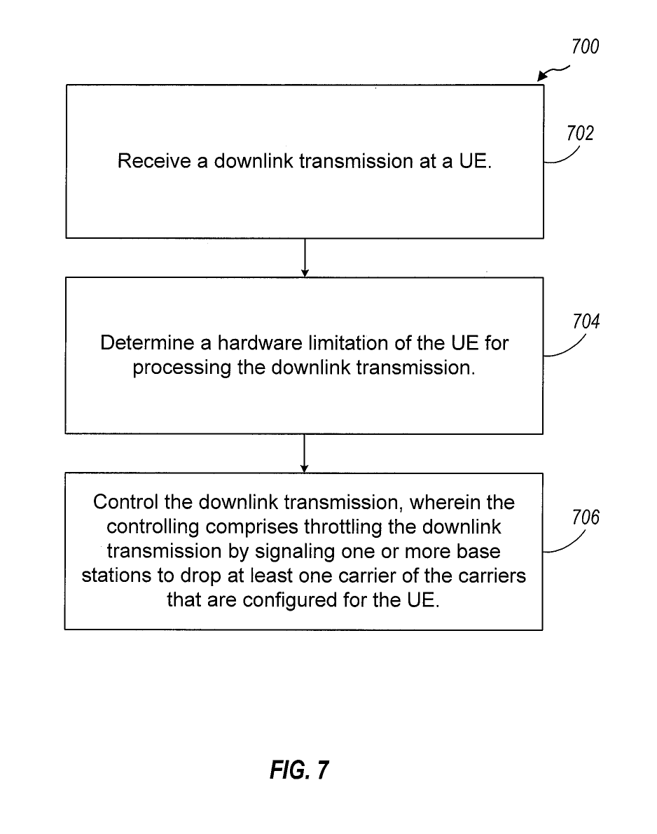

FIG. 7 is a functional block diagram 700 illustrating exemplary blocks executed by a UE to implement one aspect of the present disclosure. At block 702, the UE may receive a downlink transmission. At block 704, the UE may determine its hardware limitations for processing the downlink transmission. The hardware limitations may include the UE's Bus and/or CPU peak throughput and any UE's hardware for processing the received transmission. In response to the UE's hardware limitations, at block 706, the UE may control the downlink transmission. The controlling may comprise throttling the downlink transmission by signaling one or more base stations to drop at least one carrier of the carriers that are configured for the UE. Accordingly, the UE may switch from a carrier aggregation mode to a non-carrier aggregation mode to throttle back the downlink data transmissions when the UE's hardware limitations limit or about to limit its capability to support voice services and data services simultaneously in a carrier aggregation mode or when the UE is approaching its hardware throughput limitations.

In order to request one or more base stations to drop at least one carrier, the UE may signal the base station a false indicator value. The false indicator value indicates false channel state information of the carrier to be dropped. The false channel state information of the carrier is worse than actual channel state information of the carrier to be dropped. The false indicator value may be a false channel quality indicator (CQI) value. The false indicator value may be pre-determined to be used to cause the one or more base stations to drop the at least one carrier. Additionally, the UE may increase the frequency or amount of transmission of negative acknowledgements (NACKs) for the data transmission that exceeds the frequency or amount of transmission of NACKs needed to report errors in the data transmission.

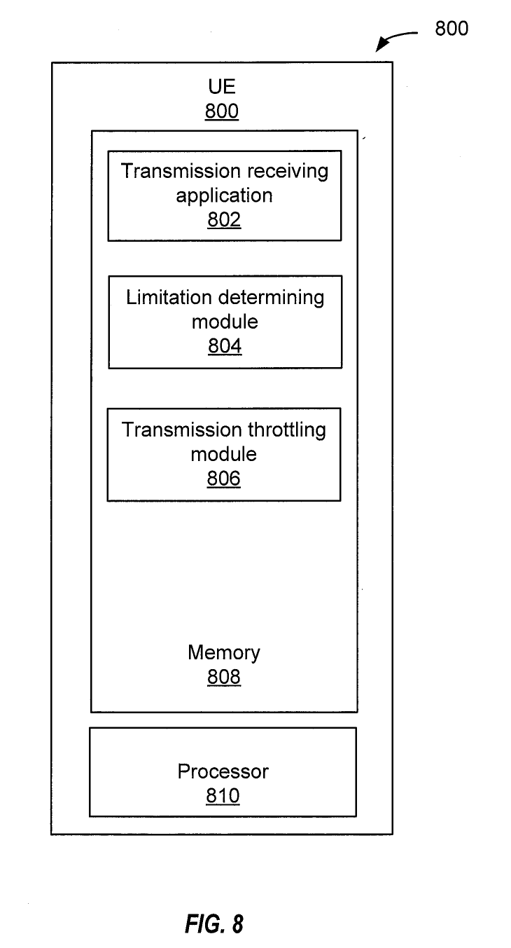

FIG. 8 is a block diagram of a UE 800 in a communication network according to one aspect of the present disclosure. UE 800 may include a memory 808 that may store data and program codes for execution of a transmission receiving module 802, a limitation determining module 804, and a transmission throttling module 806. UE 800 may be a simultaneous voice and LTE (SVLTE) UEs or Multi-SIM UEs. Transmission receiving module 802 may be used to receive a downlink transmission. For example, transmission receiving module 802 may receive the downlink transmission from one or more base stations. Limitation determining module 804 may be used to determine hardware limitations of UE 800 for processing the downlink transmission. Transmission throttling module 806 may be used to control the downlink transmission by throttling the received downlink transmission. For example, UE 800 may signal one or more base stations to drop at least one carrier of the carriers that are configured for UE 800.

UE 800 may also include a processor 810 to perform or execute program codes that are stored in memory 808 and control the other components of UE 800. Processor 810 and/or other processors at UE 800 may also perform or direct the execution of the functional blocks.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 4-6 may comprise processors, electronics devices, hardware devices, electronics components, logical circuits, memories, software codes, firmware codes, etc., or any combination thereof.

Those of skill would further appreciate that the various illustrative logical blocks, modules, circuits, and process steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. A computer-readable storage medium may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, non-transitory connections may properly be included within the definition of computer-readable medium. For example, if the instructions are transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
determining, by a user equipment (UE), a downlink low data-rate transmission received at the UE;
measuring, by the UE, a performance metric indicating performance of the downlink low data-rate transmission; and
controlling, by the UE, the downlink low data-rate transmission, wherein the controlling comprises dynamically adjusting a number of receiving antennas in use by the UE in response to comparison results of the performance metric and a threshold value.

2. The method of claim 1, further comprising determining the threshold value.

3. The method of claim 1, wherein the controlling the downlink low data-rate transmission comprises throttling the downlink low data-rate transmission when the measured performance metric is higher than the threshold value.

4. The method of claim 3, wherein the throttling the downlink low data-rate transmission comprises decreasing the number of receiving antennas in use by the UE by decreasing a rank indicator value.

5. The method of claim 1, wherein the adjusting the number of receiving antennas in use by the UE comprises increasing the number of receiving antennas in use by the UE by increasing a rank indicator value when the measured performance metric is lower than the threshold value.

6. The method of claim 1, the downlink low data-rate transmission includes voice transmission.

7. The method of claim 6, wherein a performance metric of the voice transmission is determined based on one or more of: initiation time of the voice transmission, a drop rate of the voice transmission, or a mean opinion score.

8. An apparatus for wireless communication, comprising:
means for determining a downlink low data-rate transmission received at a user equipment (UE);
means for measuring a performance metric indicating performance of the downlink low data-rate transmission; and
means for controlling the downlink low data-rate transmission, wherein the means for controlling comprises means for dynamically adjusting a number of receiving antennas in use by the UE in response to comparison results of the performance metric and a threshold value.

9. The apparatus of claim 8, further comprising means for determining the threshold value.

10. The apparatus of claim 8, wherein the means for controlling the downlink low data-rate transmission comprises means for throttling the downlink low data-rate transmission when the measured performance metric is higher than the threshold value.

11. The apparatus of claim 10, wherein the means for throttling the downlink low data-rate transmission comprises means for decreasing the number of receiving antennas in use by the UE by decreasing a rank indicator value.

12. The apparatus of claim 8, wherein the means for adjusting the number of receiving antennas in use by the UE comprises means for increasing the number of receiving antennas in use by the UE by increasing a rank indicator value when the measured performance metric is lower than the threshold value.

13. The apparatus of claim 8, the downlink low data-rate transmission includes voice transmission.

14. The apparatus of claim 13, wherein a performance metric of the voice transmission is determined based on one or more of: initiation time of the voice transmission, a drop rate of the voice transmission, or a mean opinion score.

15. A non-transitory computer-readable medium having program code recorded thereon, the program code, comprising:
program code for causing a computer to determine a downlink low data-rate transmission received at a user equipment (UE);
program code for causing the computer to measure a performance metric indicating performance of the downlink low data-rate transmission; and
program code for causing the computer to control the downlink low data-rate transmission, wherein the program code to control comprises program code to dynamically adjust a number of receiving antennas in use by the UE in response to comparison results of the performance metric and a threshold value.

16. The non-transitory computer-readable medium of claim 15, further comprising program code to determine the threshold value.

17. The non-transitory computer-readable medium of claim 15, wherein the program code to control the downlink low data-rate transmission comprises program code to throttle the downlink low data-rate transmission when the measured performance metric is higher than the threshold value.

18. The non-transitory computer-readable medium of claim 17, wherein the program code to throttle the downlink low data-rate transmission comprises program code to decrease the number of receiving antennas in use by the UE by decreasing a rank indicator value.

19. The non-transitory computer-readable medium of claim 15, wherein the program code to adjust the number of receiving antennas in use by the UE comprises program code to increase the number of receiving antennas in use by the UE by increasing a rank indicator value when the measured performance metric is lower than the threshold value.

20. The non-transitory computer-readable medium of claim 15, the downlink low data-rate transmission includes voice transmission.

21. The non-transitory computer-readable medium of claim 20, wherein a performance metric of the voice transmission is determined based on one or more of:
initiation time of the voice transmission, a drop rate of the voice transmission, or a mean opinion score.

22. A wireless communication apparatus comprising:
at least one processor; and
a memory coupled to the at least one processor, wherein the at least one processor is configured to:
determine a downlink low data-rate transmission received at a user equipment (UE);
measure a performance metric indicating performance of the downlink low data-rate transmission; and
control the downlink low data-rate transmission, wherein the configuration of the at least one processor to control comprises configuration to dynamically adjust a number of receiving antennas in use by the UE in response to comparison results of the performance metric and a threshold value.

23. The apparatus of claim 22, wherein the at least one processor is further configured to determine the threshold value.

24. The apparatus of claim 22, wherein the configuration of the at least one processor to control the downlink low data-rate transmission comprises configuration to throttle the downlink low data-rate transmission when the measured performance metric is higher than the threshold value.

25. The apparatus of claim 24, wherein the configuration of the at least one processor to throttle the downlink low data-rate transmission comprises configuration to decrease the number of receiving antennas in use by the UE by decreasing a rank indicator value.

26. The apparatus of claim 22, wherein the configuration of the at least one processor to adjust the number of receiving antennas in use by the UE comprises configuration to increase the number of receiving antennas in use by the UE by increasing a rank indicator value when the measured performance metric is lower than the threshold value.

27. The apparatus of claim 22, the downlink low data-rate transmission includes voice transmission.

28. The apparatus of claim 27, wherein a performance metric of the voice transmission is determined based on one or more of: initiation time of the voice transmission, a drop rate of the voice transmission, or a mean opinion score.
